(19) United States
(12) Patent Application Publication
(10) Pub. No.: US 2011/0281560 A1
(43) Pub. Date: Nov. 17, 2011

(54) METHOD AND APPARATUS FOR FACILITATING COST-OPTIMIZED MOBILE MESSAGING

(75) Inventors: Yashwant Singh Chouhan, Bangalore (IN); Amarendra Kumar Srivastava, Lucknow (IN)

(73) Assignee: INTUIT INC., Mountain View, CA (US)

(21) Appl. No.: 12/780,306

(22) Filed: May 14, 2010

(51) Int. Cl. H04W 4/12; H04L 12/58; H04M 3/42

(52) U.S. Cl. 455/412.1; 455/466; 455/414.1

(57) ABSTRACT

One embodiment of the present invention provides a system for facilitating cost-optimized mobile messaging. During operation, the system receives an encoded text message at a mobile device. Next, the system replaces a sub-string in the encoded text message with a corresponding sub-string from a data-dictionary to create a decoded text message. Finally, the system displays the decoded text message on the mobile device. Note that this helps to reduce costs since small sub-strings in the encoded text message can be replaced with large sub-strings in the decoded text message, thereby allowing a larger message to be sent via the SMS protocol without sending as many characters.

### RELATED ART

Consumers are increasing relying on Short Message Service (SMS) text messages as a communication channel for sending and receiving information. In 2008 alone, over 4.1 trillion SMS text messages were sent. This represents a global commercial market of over $81 billion, and is increasing at a healthy rate.

Businesses are beginning to use SMS text messages on a larger scale, and are consequently looking at ways to contain the significant costs associated with sending large volumes of SMS text messages. For example, SMS text messages are typically limited to 140 ASCII characters or 70 Unicode characters. Hence, if a business sends an SMS text message that exceeds these limits, the SMS text message is broken up into multiple SMS text messages and the cost of sending the SMS text message increases. For this reason, businesses are forced to choose between relaying less information to their customers and paying for multiple messages.

### SUMMARY

One embodiment of the present invention provides a system for facilitating cost-optimized mobile messaging. During operation, the system receives an encoded text message at a mobile device. Next, the system replaces a sub-string in the encoded text message with a corresponding sub-string from a data-dictionary to create a decoded text message. Finally, the system displays the decoded text message on the mobile device.

Note that this helps to reduce costs since small sub-strings in the encoded text message can be replaced with large sub-strings in the decoded text message, thereby allowing a larger message to be sent via the SMS protocol without sending as many characters.

In some embodiments of the present invention, the system also determines the data-dictionary for the encoded text message. Note that this can be handled on a per message, per sender, or a per device basis.

In some embodiments of the present invention, determining the data-dictionary for the encoded text message involves considering a port number on which the encoded text message was received.

In some embodiments of the present invention, determining the data-dictionary for the encoded text message involves analyzing a sub-string in the encoded text message that identifies the corresponding data-dictionary.

In some embodiments of the present invention, determining the data-dictionary for the encoded text message further involves determining if the data-dictionary is stored locally on the mobile device. If not, the system retrieves the data-dictionary from a remote data-dictionary repository over a different communication protocol than a communication protocol used to receive the encoded text message.

In some embodiments of the present invention, the system receives a new data-dictionary at the mobile device, and then stores the new data-dictionary in a local data-dictionary repository.

In some embodiments of the present invention, the system receives a second text message from the user at the mobile device to send to a second user. Next, the system determines a second data-dictionary for the second user. The system then encodes the second text message with the second data-dictionary to create a second encoded text message. Finally, the system sends the second encoded text message to the second user.

In some embodiments of the present invention, the encoded text message is a Short Message Service (SMS) text message.

In some embodiments of the present invention, the system replaces the sub-string in the encoded text message with a corresponding item of media content. Finally, the system plays the item of media content on the mobile device.

### BRIEF DESCRIPTION OF THE FIGURES

FIG. 1 illustrates a computing environment in accordance with an embodiment of the present invention.

FIG. 2 illustrates a system in accordance with an embodiment of the present invention.

FIG. 3 presents a flow chart illustrating the process of receiving a cost-optimized text message in accordance with an embodiment of the present invention.

TABLE 1 illustrates an encoded text message in accordance with an embodiment of the present invention.

TABLE 2 illustrates a corresponding decoded text message in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored on a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

Embodiments of the present invention facilitate cost-optimized mobile messaging by encoding long messages that exceed the character-limit of a single text message in a manner that reduces the number of characters of the message so that fewer text messages will be sent, thus reducing cost.

More specifically, one embodiment of the present invention provides a system for facilitating cost-optimized mobile messaging. During operation, the system receives an encoded text message at a mobile device, such as a cell phone or smart-phone. Next, the system replaces a sub-string in the encoded text message with a corresponding sub-string from a data-dictionary to create a decoded text message. For example, in one embodiment the sub-string “DLR” could be decoded to “Disneyland Resort.” In this example, three characters are used in the encoded text message to represent 17 characters in the decoded text message. Finally, the system displays the decoded text message on the mobile device.

TABLE 1 illustrates an encoded text message in accordance with an embodiment of the present invention. This text message includes 93 characters, and is difficult to understand outside of the context of the appropriate data-dictionary. As illustrated, the text message in TABLE 1 can be sent to a mobile device via a single Short Message Service (SMS) message.

TABLE 1
ENCODED TEXT MESSAGE

T 1 25-30 2 26-34 3 24-39 4 24-39 998877556645 P 1 12-16
2 13-15 3 13-16 4 13-16 998877556646

TABLE 2 illustrates a corresponding decoded text message in accordance with an embodiment of the present invention. Note that the decoded text message of TABLE 2 corresponds to the encoded text message of TABLE 1. The decoded text message of TABLE 2 exceeds the SMS limit of 140 ASCII characters, and therefore would have required at least two SMS messages to be sent in unencoded form.

TABLE 2
DECODED TEXT MESSAGE
Intuit Farmer's Market Quotes
Tomatoes

| | |
|---|---|
| Market 1 | 25-30 |
| Market 2 | 26-34 |
| Market 3 | 24-39 |
| Market 4 | 24-39 |
| Agent Number | 998877556645 |

Potatoes

| | |
|---|---|
| Market 1 | 12-16 |
| Market 2 | 13-15 |
| Market 3 | 13-16 |
| Market 4 | 13-16 |
| Agent Number | 998877556646 |

In this example, two SMS messages were reduced into a single SMS message, resulting in a 50% cost savings. In the case of Unicode messages and/or text messages with even more characters, potentially greater savings can be realized.

Note that, in the example illustrated in TABLES 1 and 2, the data-dictionary includes some style and form guides for the decoded text message. For example, the data-dictionary might stipulate that every text message decoded with the data-dictionary includes a pre-determined header, such as “Intuit Farmer's Market Quotes.”

Furthermore, the data-dictionary may include directions for formatting. For example, note that, while the encoded text message in TABLE 1 includes a simple character stream with no line breaks, the corresponding decoded text message of TABLE 2 includes line breaks after each quote, and blank lines between quote groups. These formatting guides can facilitate increased readability of the text message without requiring additional formatting characters to be sent in the encoded text message.

In some embodiments of the present invention, the system determines the data-dictionary for the encoded text message. Note that, in some embodiments of the present invention, the mobile device may include multiple data-dictionaries specific to different businesses, products, services, etc. In these embodiments, the system first determines which data-dictionary was used to encode the text message so that the same data-dictionary will be used to decode the text message.

In some embodiments of the present invention, determining the data-dictionary for the encoded text message involves determining a port number on which the encoded text message was received. For example, when the data-dictionary is first stored on the mobile device, the system can assign a port number to the data-dictionary. In this example, when a new text message is received on the specified port, the system knows to use the data-dictionary assigned to the port.

In some embodiments of the present invention, determining the data-dictionary for the encoded text message involves analyzing a sub-string in the encoded text message that identifies the corresponding data-dictionary.

Note that the text message may start with a special character to indicate that the following message is encoded. Furthermore, the text message may include an identifier immediately following the special character to indicate which data-dictionary to use to decode the encoded text message. For example, an encoded text message might start with the sub-string “|A4:” indicating that the text message is encoded with data-dictionary “A4.”

In some embodiments of the present invention, determining the data-dictionary for the encoded text message further involves determining if the data-dictionary is stored locally on the mobile device. If not, the system retrieves the data-dictionary from a remote data-dictionary repository over a different communication protocol than a communication protocol used to receive the encoded text message.

For example, if a mobile device receives an encoded SMS text message, and the device determines that the corresponding data-dictionary is not already loaded on the mobile device, the mobile device may request the data-dictionary over an alternative communication channel, such as Wi-Fi® or Bluetooth®. Although the data-dictionary can be received over any communication channel, including via SMS messages, it might make financial sense to only receive the data-dictionary over less costly communication channels than the communication channel over which the original encoded text message was received.

In some embodiments of the present invention, the system receives a new data-dictionary at the mobile device. Finally, the system stores the new data-dictionary in a local data-dictionary repository. Note that in some embodiments, the system includes a local repository of multiple data-dictionaries. In this embodiment, the system periodically receives new data-dictionaries to store locally on the mobile device, as well as receiving updates to existing data-dictionaries.

Note that once a new data-dictionary is received, in some embodiments of the present invention, encoded text messages already received at the mobile device may be decoded with the new data-dictionary. In this manner, text messages that could not be decoded because the data-dictionary was unavailable on the mobile device can be saved for viewing at a subsequent time when the data-dictionary does become available. Note that there may be advantages for an organization to send out encoded text messages prior to the release of the data-dictionary, and then to release the data-dictionary at a specified time.

In some embodiments of the present invention, the system receives a second text message from the user at the mobile device to send to a second user. Next, the system determines a second data-dictionary for the second user. The system then encodes the second text message with the second data-dictionary to create a second encoded text message. Finally, the system sends the second encoded text message to the second user.

Note that some embodiments of the present invention facilitate encoding text messages on the mobile device to send to remote users. In the previous examples related to receiving and decoding encoded text messages at the mobile device, the mobile device might also act as the encoder and sender of the encoded text messages.

For example, Bob decides to send a long text message to his friend Sally to give her directions to drive to his vacation home at Lake Tahoe. At some point prior to sending the text message, Bob and Sally registered for a text message encoding service and downloaded a data-dictionary including a list of commonly used words to their mobile devices. Note that this data-dictionary can be customized by Bob and Sally to include common terms and phrases that they use often.

Bob starts the process by selecting Sally as the recipient for the text message, and proceeds to type out a list of directions for driving to the vacation home. Upon pressing send, the system determines that both Bob and Sally have registered for the same data-dictionary. The system then proceeds to encode the text, and send the encoded text message to Sally's mobile device indicating that the message is encoded.

Upon receiving the encoded text message, Sally's mobile device determines the data-dictionary that Bob used to encode the encoded text message and decodes the encoded text message. Finally, Sally's mobile device displays the decoded text message to Sally.

Note that this is an advantage to both Bob and Sally because Bob can send a message to Sally that would have required two separate SMS text messages in an unencoded form, but only require one SMS text message to be exchanged in an encoded form. Bob is charged with sending only one SMS text message, rather than two; and Sally is charged with receiving only one SMS text message, rather than two.

In some embodiments of the present invention, the encoded text message is a Short Message Service (SMS) text message. Note that, while embodiments of the present invention discuss text messaging and SMS messages, the present invention is not meant to be limited to text messages and SMS messages. Moreover, any type of mobile messaging via any protocol that can be understood by a mobile device may be used in embodiments of the present invention.

In some embodiments of the present invention, the system replaces the sub-string in the encoded text message with a corresponding item of media content. Finally, the system plays the item of media content on the mobile device. Note that the item of media content can include any type of content capable of being played or displayed on the mobile device, including audio, video, and pictures.

For example, in some embodiments of the present invention, a sub-string in the encoded text message is converted to an audio stream and played to the user of the mobile device. For instance, Yashwant can send a text message to Soon-Yi stating “my name is Yashwant.” The system can then encode the text message to Soon-Yi as “m n i Yashwant.” When Soon-Yi receives the text message at her mobile device, the mobile device decodes the encoded text message and converts the sub-string to an audio stream. When Soon-Yi opens the text message o her mobile device, the encoded message is processed and an audio content is generated and played on the device.

In some embodiments of the present invention, the audio content can even be translated in a particular language. In this manner, the same message “m n I Yashwant” is read out as “Je m'appelle Yashwant” for a French recipient or “Mein Name ist Yashwant” for a Dutch recipient or “My name is Yashwant” for an English recipient. The language setting for translation and any other such settings can be read from the receiving device configuration.

Note that these embodiments are particularly applicable for various parts of world where mobile telephony has penetrated but illiteracy is rampant. It is useful for people who can use the mobile phone and can use the digits on the dial pad, but cannot compose short messages. These individuals can use a fixed combination of keys to play the incoming message.

### Computing Environment

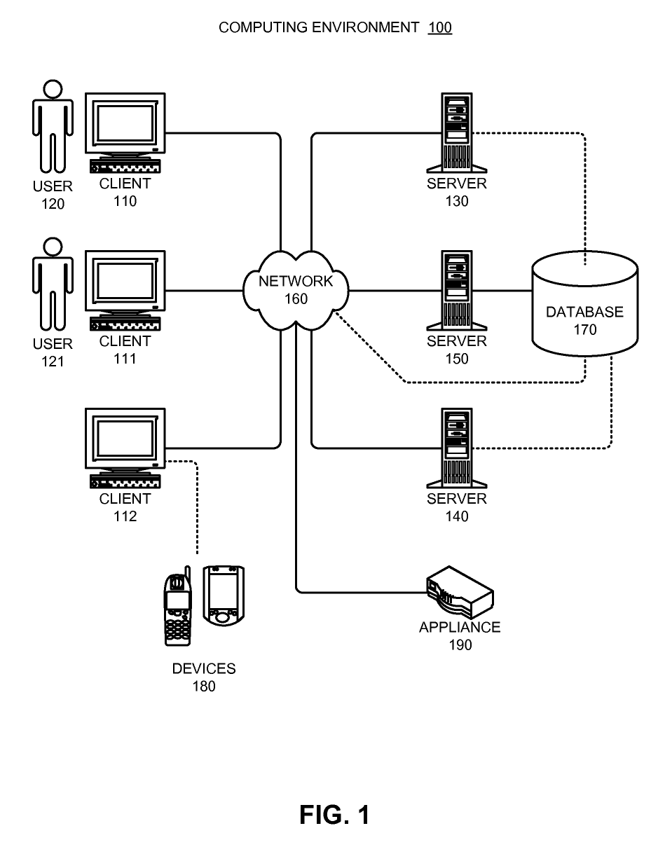

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120 and 121, servers 130-150, network 160, database 170, devices 180, and appliance 190.

Clients 110-112 can include any node on a network including computational capability and including a mechanism for communicating across the network. Additionally, clients 110-112 may comprise a tier in an n-tier application architecture, wherein clients 110-112 perform as servers (servicing requests from lower tiers or users), and wherein clients 110-112 perform as clients (forwarding the requests to a higher tier).

Similarly, servers 130-150 can generally include any node on a network including a mechanism for servicing requests from a client for computational and/or data storage resources. Servers 130-150 can participate in an advanced computing cluster, or can act as stand-alone servers. In one embodiment of the present invention, server 140 is an online “hot spare” of server 150.

Users 120 and 121 can include: an individual; a group of individuals; an organization; a group of organizations; a computing system; a group of computing systems; or any other entity that can interact with computing environment 100.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

Database 170 can include any type of system for storing data in non-volatile storage. This includes, but is not limited to, systems based upon magnetic, optical, or magneto-optical storage devices, as well as storage devices based on flash memory and/or battery-backed up memory. Note that database 170 can be coupled: to a server (such as server 150), to a client, or directly to a network.

Devices 180 can include any type of electronic device that can be coupled to a client, such as client 112. This includes, but is not limited to, cell phones, personal digital assistants (PDAs), smart-phones, personal music players (such as MP3 players), gaming systems, digital cameras, video cameras, portable storage media, or any other device that can be coupled to the client. Note that, in some embodiments of the present invention, devices 180 can be coupled directly to network 160 and can function in the same manner as clients 110-112.

Appliance 190 can include any type of appliance that can be coupled to network 160. This includes, but is not limited to, routers, switches, load balancers, network accelerators, and specialty processors. Appliance 190 may act as a gateway, a proxy, or a translator between server 140 and network 160.

Note that different embodiments of the present invention may use different system configurations, and are not limited to the system configuration illustrated in computing environment 100. In general, any device that is capable of communicating via network 160 may incorporate elements of the present invention.

### System

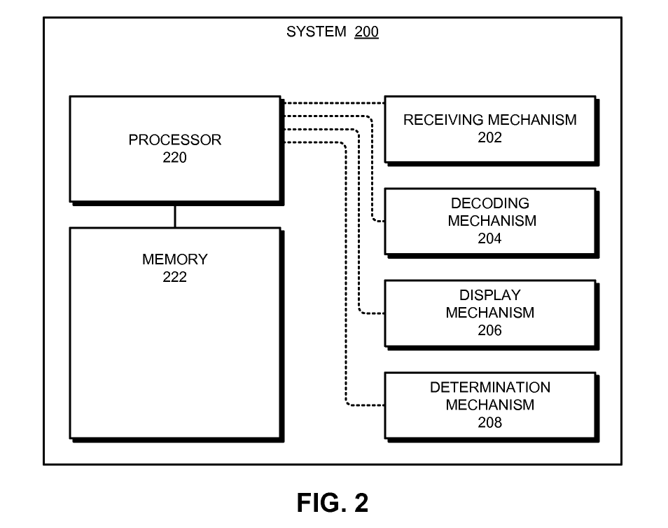

FIG. 2 illustrates a system 200 in accordance with an embodiment of the present invention. As illustrated in FIG. 2, system 200 can comprise server 150, database 170, appliance 190, client 110, devices 180, or any combination thereof. System 200 can also include receiving mechanism 202, decoding mechanism 204, display mechanism 206, determination mechanism 208, processor 220, and memory 222.

In some embodiments of the present invention, system 200 comprises a cell phone, a smart-phone, a Personal Digital Assistant (PDA), or any other device capable of sending and/or receiving a mobile message and displaying the mobile message to user 120.

### Receiving a Cost-Optimized Text Message

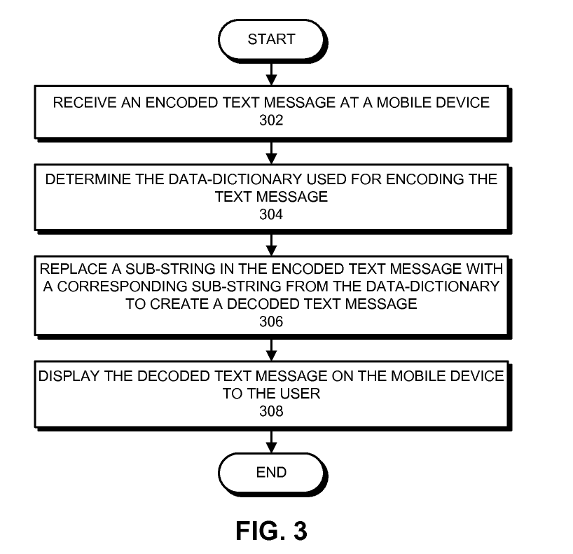

FIG. 3 presents a flow chart illustrating the process of receiving a cost-optimized text message in accordance with an embodiment of the present invention.

During operation, receiving mechanism 202 receives an encoded text message at mobile device 180 (operation 302). Determination mechanism 208 then determines the data-dictionary used for encoding the encoded text message (operation 304).

Note that, as described previously, determining the data-dictionary used for encoding the encoded text message may involve determining a port number via which the encoded text message was received or analyzing the encoded text message for a sub-string that indicates the data-dictionary. Also note that the data-dictionary has been pre-loaded on mobile device 180.

In some embodiments of the present invention, a specific sender may be tied to a specific data-dictionary. In these embodiments, mobile device 180 always uses the data-dictionary associated with a specific sender when receiving text messages from the specific sender.

Next, decoding mechanism 204 replaces a sub-string in the encoded text message with a corresponding sub-string from the data-dictionary to create a decoded text message (operation 306). Note that this includes applying form and formatting rules from the data-dictionary.

Finally, display mechanism 206 displays the decoded text message on mobile device 180 to user 120 (operation 308).

The foregoing descriptions of embodiments of the present invention have been presented only for purposes of illustration and description.

They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for facilitating cost-optimized mobile messaging, the method comprising:
receiving an encoded text message at a mobile device;
replacing a sub-string in the encoded text message with a corresponding sub-string from a data-dictionary to create a decoded text message; and
displaying the decoded text message on the mobile device.

2. The computer-implemented method of claim 1, further comprising determining the data-dictionary for the encoded text message.

3. The computer-implemented method of claim 2, wherein determining the data-dictionary for the encoded text message involves considering a port number on which the encoded text message was received.

4. The computer-implemented method of claim 2, wherein determining the data-dictionary for the encoded text message involves analyzing a sub-string in the encoded text message that identifies the corresponding data-dictionary.

5. The computer-implemented method of claim 2, wherein determining the data-dictionary for the encoded text message further involves:
determining if the data-dictionary is stored locally on the mobile device; and
if not, retrieving the data-dictionary from a remote data-dictionary repository over a different communication protocol than a communication protocol used to receive the encoded text message.

6. The computer-implemented method of claim 1, further comprising:
receiving a new data-dictionary at the mobile device; and
storing the new data-dictionary in a local data-dictionary repository.

7. The computer-implemented method of claim 1, further comprising:
receiving a second text message from the user at the mobile device to send to a second user;
determining a second data-dictionary for the second user;
encoding the second text message with the second data-dictionary to create a second encoded text message; and
sending the second encoded text message to the second user.

8. The computer-implemented method of claim 1, wherein the encoded text message is a Short Message Service (SMS) text message.

9. The computer-implemented method of claim 1, further comprising:
replacing the sub-string in the encoded text message with a corresponding item of media content; and
playing the item of media content on the mobile device.

10. A non-transitory computer-readable storage medium storing instructions that when executed by a computer cause the computer to perform a method for facilitating cost-optimized mobile messaging, the method comprising:
receiving an encoded text message at a mobile device;
replacing a sub-string in the encoded text message with a corresponding sub-string from a data-dictionary to create a decoded text message; and
displaying the decoded text message on the mobile device.

11. The non-transitory computer-readable storage medium of claim 10, wherein the method further comprises determining the data-dictionary for the encoded text message.

12. The non-transitory computer-readable storage medium of claim 11, wherein determining the data-dictionary for the encoded text message involves considering a port number on which the encoded text message was received.

13. The non-transitory computer-readable storage medium of claim 11, wherein determining the data-dictionary for the encoded text message involves analyzing a sub-string in the encoded text message that identifies the corresponding data-dictionary.

14. The non-transitory computer-readable storage medium of claim 11, wherein determining the data-dictionary for the encoded text message further involves:
determining if the data-dictionary is stored locally on the mobile device; and
if not, retrieving the data-dictionary from a remote data-dictionary repository over a different communication protocol than a communication protocol used to receive the encoded text message.

15. The non-transitory computer-readable storage medium of claim 10, wherein the method further comprises:
receiving a new data-dictionary at the mobile device; and
storing the new data-dictionary in a local data-dictionary repository.

16. The non-transitory computer-readable storage medium of claim 10, wherein the method further comprises:
receiving a second text message from the user at the mobile device to send to a second user;
determining a second data-dictionary for the second user;
encoding the second text message with the second data-dictionary to create a second encoded text message; and
sending the second encoded text message to the second user.

17. The non-transitory computer-readable storage medium of claim 10, wherein the encoded text message is a Short Message Service (SMS) text message.

18. The non-transitory computer-readable storage medium of claim 10, wherein the method further comprises:
replacing the sub-string in the encoded text message with a corresponding item of media content; and
playing the item of media content on the mobile device.

19. An apparatus for facilitating cost-optimized mobile messaging, comprising:
a memory;
a processor;
a receiving mechanism configured to receive an encoded text message at a mobile device;
a decoding mechanism configured to replace a sub-string in the encoded text message with a corresponding sub-string from a data-dictionary to create a decoded text message; and
a display mechanism configured to display the decoded text message on the mobile device.

20. The apparatus of claim 19, further comprising a determination mechanism configured to determine the data-dictionary for the encoded text message.
